(19) United States
(12) Patent Application Publication
(10) Pub. No.: US 2017/0180652 A1
(43) Pub. Date: Jun. 22, 2017

(54) ENHANCED IMAGING

(71) Applicants: Jim S. Baca, Corrales, NM (US); David Stanasolovich, Beaverton, OR (US); Neal Patrick Smith, Folsom, CA (US); Yogeshwara Krishnan, Dallas, TX (US)

(72) Inventors: Jim S. Baca, Corrales, NM (US); David Stanasolovich, Beaverton, OR (US); Neal Patrick Smith, Folsom, CA (US); Yogeshwara Krishnan, Dallas, TX (US)

(21) Appl. No.: 14/976,489

(22) Filed: Dec. 21, 2015

(51) Int. Cl. H04N 5/262; G06K 9/62; H04N 13/00; H04N 13/02

(52) U.S. Cl. CPC H04N 5/2621; H04N 13/0271; H04N 13/0292; G06K 9/6267; H04N 13/0048

(57) ABSTRACT

System and techniques for enhanced imaging are described herein. Light from an environment may be sampled to create an image. Energy reflected from the environment may also be sampled to create a depth image of the environment. A classifier may be applied to both the image and the depth image to provide a set of object properties for an object in the environment. A composite image may be constructed that includes portions of the image and depth image representing the object as well as the object properties.

### TECHNICAL FIELD

Embodiments described herein generally relate to computer imaging and more specifically to enhanced imaging.

### BACKGROUND

Cameras generally capture light from a scene to produce an image of the scene. Some cameras can also capture depth or disparity information. These multi-mode cameras are becoming more ubiquitous in the environment, from mobile phones to gaming systems, etc. Generally, the image data is provided separately from the depth image data to consuming applications (e.g., devices, software, etc.). These applications then combine, or separately use, the information as each individual application sees fit.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for enhanced imaging, according to an embodiment.

FIG. 2 illustrates a block diagram of an example of a system for enhanced imaging, according to an embodiment.

FIG. 3 illustrates an example of a method for enhanced imaging, according to an embodiment.

FIG. 4 illustrates an example of a method for enhanced imaging, according to an embodiment.

FIG. 5 is a block diagram illustrating an example of a machine upon which one or more embodiments may be implemented.

### DETAILED DESCRIPTION

Current image capture systems do not provide any other context with regard to objects (e.g., things, planes, shapes, etc.) that are detectable in the captured images. While individual applications may process the data to make their own determinations, an application developer cannot, from the capture data alone, know what the plane is made of (e.g., is it a wood table top or a cement floor). Thus, the presently described enhanced imaging provides such contextual and object information in the captured image itself, freeing application developers from onerous hardware to make the determinations themselves, and also allowing application developers to provide richer interactions with the resultant media and their applications.

The enhanced imaging system described herein includes contextual information (e.g., hardness, sound absorption, movement characteristics, types of objects, planes, etc.) of detected objects along with the image and depth image data to enhance the resultant media. This enhanced media may be used to create video effects, or other applications with less work from the consuming application. This system uses a number of object identification techniques, such as deep learning machines, stochastic classifiers, etc. Further, the enhanced imaging may include haptic information associated with each object to provide as tactile feedback users interacting with the content.

The system uses both visual light (e.g., read-green-blue (RGB)) images and corresponding depth information captured at a sensor or sensor array to provide more context to objects identified in pictures (e.g., frames) or video. This allows an application developer to provide enhanced effects (e.g., animation, interaction, etc.) in a scene used in their application. Although the contextual tagging of imagery may be done via live feed (e.g., stream), it may also be effective when added in a post processing environment.

Further, the system may maintain a history of different objects detected in a scene. As the particular objects are tracked from frame to frame, for example, the editor may determine, for example, that a particular dog or person was in the photo or video and embed that information right in the file. Thus, if the user names the dog in one scene, for example, the name could be applied to other scenes, photos, clips, etc. in which the dog is identified. Accordingly, finding all photos with Fido, or a specific person, may be reduced to a simple traversal of the meta-data in the enhanced images.

In addition to detecting and tracking objects in scenes using the combined image and depth image data, these data sources and detection may also be combined to add contextual attribute to the object, for example, via a lookup of object properties. Thus, the system may assign hardness, smoothness, plane IDs, etc. to each pixel, or segment, in the file, similarly to luminance in a grayscale image, RGB in a color image, or z value in depth image. This context information may be used for a number of application goals, like for example, assisted reality, such as identifying places for the Mars rover to drill where the soil is soft, or informing skateboarders whether a particular surface is hard enough to use for skating.

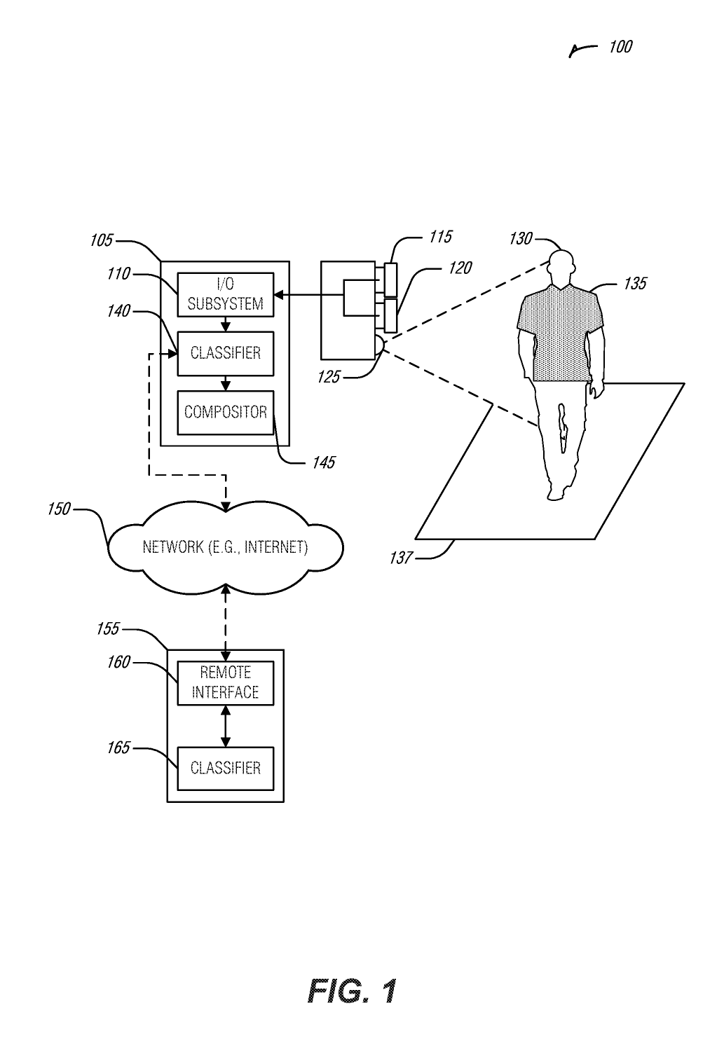

FIG. 1 is a block diagram of an example of an environment including a system 100 for enhanced imaging, according to an embodiment. The system 100 may include a local device 105. The local device 105 may include, or be communicatively coupled to, a detector 115 (e.g., a camera, or other mechanism to measure luminance of reflected light in a scene) and a depth sensor 120. The detector 115 is arranged to sample light from the environment to create an image. As used herein, image, alone, is a luminance-based representation of the scene that may also include wavelength (e.g., color) information.

The depth sensor 120 is arranged to sample reflected energy from the environment. The sampling may be contemporaneous (e.g., as close to the same time as possible) with the light sample of the detector 115. The depth sensor 120 is arranged to use the sampled reflected energy to create a depth image. As used herein, pixels, or their equivalent, in the depth image represent distance from the depth sensor 120 and an element in the scene, as opposed to luminance as in an image. In an example, the depth image pixels may be called voxels as they represent a point in three-dimensional space.

The depth sensor 120 may make use of, or include, an emitter 125 to introduce a known energy (e.g., pattern, tone, timing, etc.) into the scene, which is reflected from elements of the scene, and used by the depth sensor 120 to established distances between the elements and the depth sensor 120. In an example, the emitter 125 emits sound. The reflected energy of the sound interacting with scene elements and known timing of the sound bursts of the emitter 125 are used by the depth sensor 120 to establish distances to the elements of the scene.

In an example, the emitter 125 emits light energy into the scene. In an example, the light is patterned. For example, the pattern may include a number of short lines at various angles to each other, where the line lengths and angles are known. If the pattern interacts with a close element of the scene, the dispersive nature of the emitter 125 is not exaggerated and the line will appear closer to its length when emitted. However, when reflecting off of a distance element (e.g., a back wall), the same line will be observed by the depth sensor 120 as much longer. A variety of patterns may be used and processed by the depth sensor 120 to established the depth information. In an example, time of flight may be used by the depth sensor 120 to establish distances using a light-based emitter 125.

The local device 105 may include an input-output (I/O) subsystem 110. The I/O subsystem 110 is arranged to interact with the detector 115 and the depth sensor 120 to obtain both image and depth image data. The I/O subsystem 110 may buffer the data, or it may coordinate the activities of the detector 115 and the depth sensor 120.

The local device 105 may include a classifier 140. The classifier 140 is arranged to accept the image and depth image and provide a set of object properties of an object in the environment. Example environmental objects illustrated in FIG. 1 include a person 130 (e.g., living thing, or animate), a shirt 135 (e.g., inanimate thing), or a floor 137 (e.g., a plane). In an example, the set of object properties includes at least one of object shape (e.g., geometric shape in either two or three dimensions); object surface type (e.g., soft, hard, smooth, rough, or other texture, etc.); object hardness (e.g., between a wood table and a pillow); object identification (e.g., ball, human, cat, bicycle, shirt, floor, wall, lamp, etc.); or sound absorption (e.g., sound dampening model, sound reflection (e.g., echo) model, etc.). In an example, these properties may be the direct output of the classifier 140, such as a neural network or other machine learning technique.

In an example, the classifier 140 may perform an initial classification, such as identifying a hard wall via a machine learning, or other classification, technique and lookup one or more of the properties in a database indexed by the initial classification. Thus, in an example, the classifier 140, or other image analysis device, may be arranged to perform object recognition on the image and the depth image to identify an object. Properties of the object may then be extracted from a dataset (e.g., database, filesystem, etc.). In an example, the object identification may include segmenting, or providing a geometric representation of the object relative to the image and depth image. Such segmenting may reduce noise for the classifier input data to increase classification accuracy. In an example, the geometric shape of the segment may be given to the compositor 145 and included in the composite image.

In an example, the classifier 140 is in a device (e.g., housed together) with the detector 115 or depth sensor 120. In an example, the classifier 140 is wholly or partially remote from that device. For example, the local system 105 may be connected to a remote system 155 via a network 150, such as the Internet. The remote device 155 may include a remote interface 160, such as a simple object access protocol (SOAP) interface, a remote procedure call interface, or the like. The remote interface 160 is arranged to provide a common access point to the remote classifier 165. Additionally, the remote classifier 165 may aggregate classification for a number of different devices or users. Thus, while the local classifier 140 may perform quick and efficient classification, it may lack the computing resources or broad sampling available to the remote classifier 165 which may result in better classification of a wider variety of objects under possible worse image conditions.

The local system 105 may include a compositor 145. The compositor 145 is arranged to construct a composite image that includes a portion of the image in which the object is represented—e.g., if the object is a ball, the portion of the image will include the visual representation of the ball—a corresponding portion of the depth image—e.g., the portion of the depth image is a collection of voxels representing the ball—and the set of object properties. In an example, the depth information is treated akin to a color channel in the composite image. The set of object properties may be stored in a number of ways in the composite image. In an example, the set of object properties may be stored as meta data for a video (e.g., in a header of the video as opposed to within a frame) including the composite image. The meta data may specify which composite image (e.g., frame) of the video the particular object properties apply. In an example, the composite image may include relevant object properties in each, or some, frames of the video. In an example, a composite image may include a geometric representation of an object embedded in the composite image. In an example, the set of object properties may be attributes of the geometric representation of the object. In an example, the geometric representation of a single object may change between frames of the video. For example, geometric representation of a walking dog may change as the dog's legs move between frames of the video. In this example, however, the object identification is attached as an attribute to each geometric representation, allowing easy object identification across video frames for other applications.

The following are some example uses of the system 100:

In a first use case, combining the image data and the depth image data into a single data structure will help to improve object detection/segmentation in the identification of planes and objects as seen by the system 100. For example, the depth image may easily detect a plane where the image includes a noisy pattern, such as a quilt hanging on a wall. While visual image processing may have difficulty in addressing the visual noise in the quilt, the depth image will provide distinct edges from which to segment the visual data. Once the objects have been identified, characteristics of objects embedded in the data structure may be used directly by downstream applications to enhance the ability of an application developer to apply effects to the scene that are consistent with the physical properties of the included objects.

In an second use case, the system 100 may also track detected objects, e.g., using the visual, depth, and context information, to create a history of the object. The history may be built through multiple photographs, videos, etc. and provide observed interactions with the object to augment the classification techniques described herein. For example, a specific dog may be identified in a family picture or video through the contextual identification process. A history of the dog may be constructed from the contextual information collected from a series of pictures or videos, linking the dog to the different family members over time, different structures (e.g., houses), and surrounding landscape (e.g., presence or absence of mountains in the background). Thus, the history may operate as a contextual narrative of the dog's life, which may be employed by an application developer in other applications. Such an approach may also be employed for people, or even inanimate objects or landscapes.

In a third use case, the user may record a video of a tennis game. The user may be interested in segmenting the tennis ball and applying contextual information like firmness, texture (e.g., fuzzy, smooth, coarse, etc.), roundness etc. to the segmented ball in the enhanced image. Once the contextual information is applied, it persists throughout the video. If the user has a 3D haptic device, the user may be able to “feel” the ball (e.g., texture, shape, size, firmness, etc.) in the imagery without a sophisticated haptic client (e.g., the user may use a commercially available consumer grade client without sophisticated image processing capabilities). Application developers (e.g., virtual reality developers, game developers, augmented reality developers, etc.) may use this context in additional to the visual and depth data enhance the user's experience without employing a redundant image processing on expensive hardware. In an example, streaming the context information could make for an interesting playback experience. For example if the video had context information that indicated a haptic feedback level to coincide with the video of, for example, a rollercoaster, then, when watching the video as it gets to the bumpy section of the rollercoaster, the a chair (or other haptic device) may be vibrated, pitched, or otherwise moved in sync with the visual experience. In an example, such synchronization of the context information may be accomplished by tagging the objects in the frames rather than, for example, a separate stream of context information.

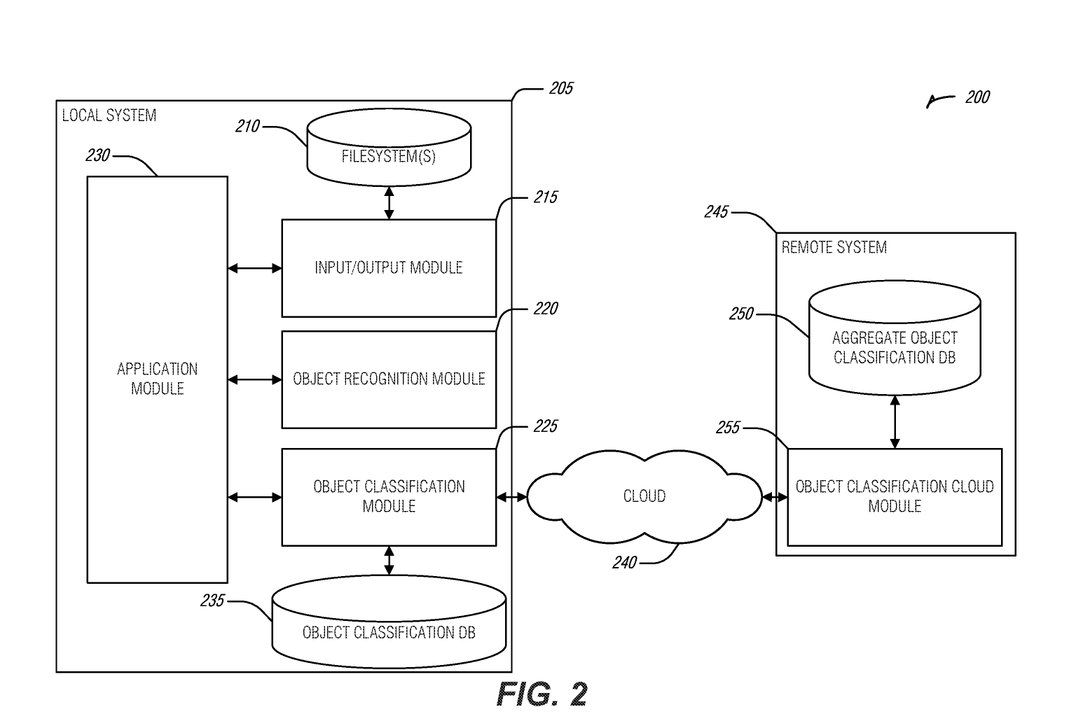

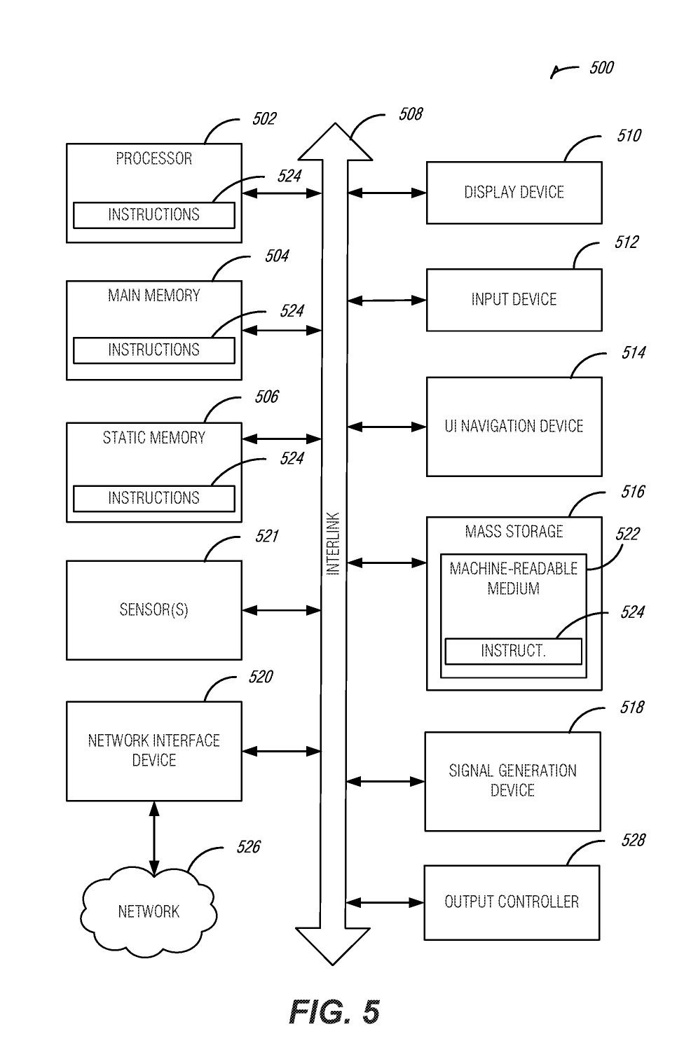

FIG. 2 illustrates a block diagram of an example of a system 200 for enhanced imaging, according to an embodiment. The system 200 may include a local system 205 and a remote system 245. Both the local system 205 and the remote system 245 are implemented in hardware, such as that described below with respect to FIG. 5.

The local system 205 is a computing device that is local to the user (e.g., a phone, gaming system, desktop computer, laptop, notebook, standalone camera, etc.). The local system 205 may include a file system 210, an input/output module 215, an object recognition module 220, an object classification module 225, an object classification database (DB) 235, and an application module 230.

The application module 230 operates to control the enhanced imaging described herein. The application module 230 may provide a user interface and also manage operation of the other modules used to produce the enhanced images. The application module 230 may be arranged to control the other modules to: read depth video; identify objects; determine object classification properties; and process the video data using the classification properties. Processing the video data using the classification properties may include: adding augmented reality objects to the video that appear to physically interact with the classified objects in the video based on the object properties; adding or modify sound based on the classified object properties; modifying the movement or shape of the classified objects based on their properties; and writing the new processed video to the file system.

The input/output module 215 may provide reading and writing functionality for depth enabled video to the application module 230. The input/output module 215 may interface with an operating system or hardware interface (e.g., a driver for a camera) to provide this functionality. The input/output module 215 may be arranged to read a depth enabled video from the file system 210 and provide it to the application module 230 (e.g., in memory, via a bus or interlink, etc.) in a format that is consumable (e.g., understood, usable, etc.) to the application module 230. The input/output module 215 may also be arranged to accept data from the application module 230 (e.g., via direct memory access (DMA), a stream, etc.) and write a depth enabled video to the file system for later retrieval.

The object recognition module 220 may identify objects within a depth enabled video. The object recognition module 220 may interface with hardware or software (e.g., a library) of the local system 205, such as a camera, a driver, etc. The object recognition module 220 may optionally interface with a remote service, for example, in the cloud 240, to use cloud 240 enabled algorithms to identify objects within the video frames. The object recognition module 220 may return the objects identified to the application module 203 for further processing.

The object classification module 225 may provide object classification services to the application module 230. The object classification module 225 may take the objects identified by the object recognition module 220 and classify them. This classification may include object properties (e.g., attributes) such as hardness, sound absorption etc. The object classification module 225 may also provide the classification data to the application module 230. The object classification module 225 may use the object classification DB 235 as a resource for context data, or other classification data that is used. The object classification module 225 may optionally use a connection (e.g., cloud 240) to a remote server (e.g., remote system 245) to incorporate aggregated classification data or it may simply make use of local data (e.g., object classification DB 235) to classify the objects.

The remote system 245 is a computing device that is remote from the user (e.g., doesn't have a physical presence with which the user interacts directly). The remote system 245 may provide a programmatic interface (e.g., application programming interface (API)) to aggregate object classification data. Because the remote system 245 is not specific to any one local system 205, it can be part of a large scalable system and generally store much more data than the local system 205 can. The remote system 245 may be implemented across multiple physical machines, but presented as a single service to the local system 205. The remote system 245 may include an object classification cloud module 255 and an aggregate object classification DB 250.

The object classification cloud module 255 may provide object classification services to the local system 205 via a remote interface (e.g., RESTful service, remote procedure call (RPC), etc.). The services may be provided via the internet or other similar networking systems and may use existing protocols such as HTTP, TCP/IP, etc.

The object classification cloud module 255 may operate similarly to the object classification module 225, or may provide a more detailed (e.g., fine grained) classification. For example, the object classification module 225 may classify an object as a dog and the object classification cloud module 255 may classify the specific breed of dog. The object classification cloud module 255 may also service multiple object classification modules on different local systems (e.g., for different users). The object classification cloud module 255 may have access to a large database of object classification data (e.g., the aggregate object classification DB 250) that may contain object attributes such as hardness, sound absorption, etc., which may be extended to include any new attributes at any time.

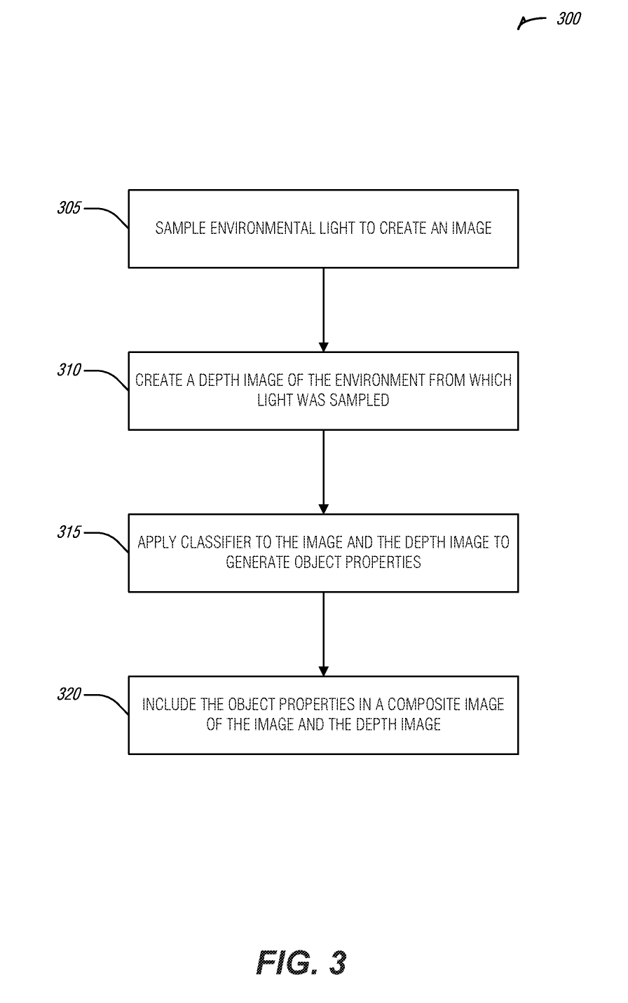

FIG. 3 illustrates an example of a method 300 for enhanced imaging, according to an embodiment. The operations of the method 300 are performed on computing hardware, such as that described above with respect to FIG. 1 or 2, or below with respect to FIG. 5 (e.g., circuit sets).

At operation 305, light is sampled from the environment to create an image.

At operation 310, reflected energy is sampled from the environment contemporaneously to the sampling of the light (operation 305) to create a depth image of the environment. In an example, sampling the reflected energy includes emitting light into the environment and sampling the emitted light. In an example, the emitted light is in a pattern. In this example, sampling the emitted light includes measuring a deformation of the pattern to create the depth image. In an example, sampling the emitted light includes measuring a time-of-flight of sub-samples of the emitted light to create the depth image.

In an example, sampling reflected energy includes emitting a sound into the environment and sampling the emitted sound. Thus, the energy used for depth imaging may be sound based on light or sound.

At operation 315, a classifier is applied to both the image and the depth image to provide a set of object properties of an object in the environment. In an example, applying the classifier includes applying a classifier in a device that includes a detector used to perform the sampling of the reflected light. In an example, applying the classifier includes applying a classifier in a device that is remote from a device that includes a detector used to perform the sampling of the reflected light.

In an example, applying the classifier includes performing object recognition on the image and the depth image to identify the object. Properties of the object may then be extracted from a dataset corresponding to the object. In an example, the dataset is remote from a device that includes a detector used to perform the sampling of the reflected light. In an example, the set of object properties includes at least one of: object shape; object surface type, object hardness, object identification, or sound absorption.

At operation 320, a composite image that includes a portion of the image in which the object is represented, a corresponding portion of the depth image, and the set of object properties is constructed. In an example, constructing the composite image includes encoding the depth image as a channel of the image. In an example, constructing the composite image includes adding a geometric representation of the object in the composite image. In an example, the geometric representation is registered (e.g., positioned) to the image. In an example, the composite image includes the set of properties as attributes to the geometric representation of the object. In an example, the composite image is a frame from a video of composite images. In this example, the geometric representation of the object may change between frames of the video.

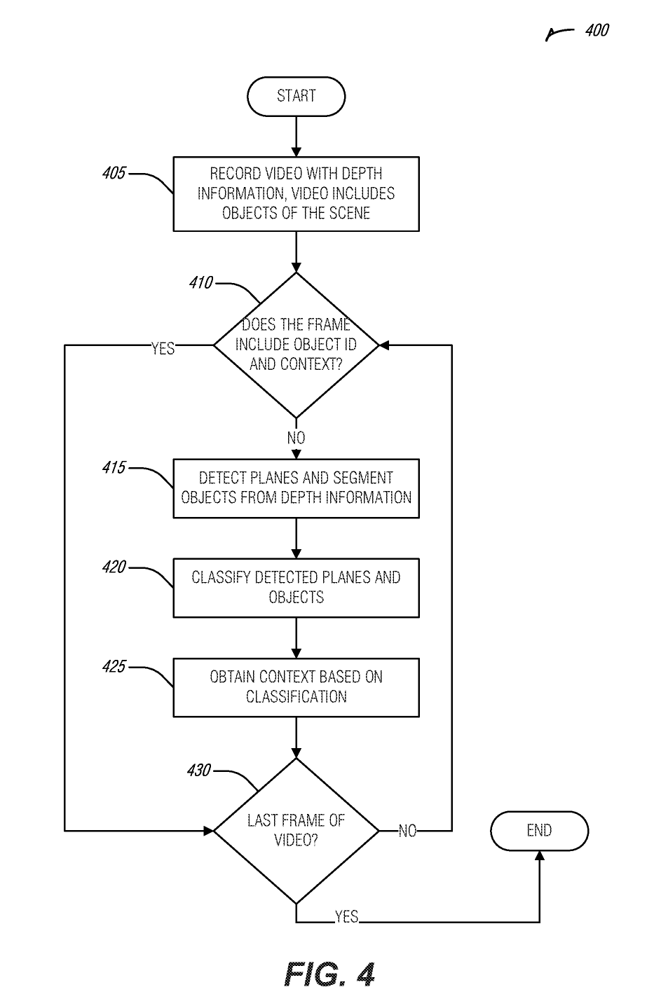

FIG. 4 illustrates an example of a method 400 for enhanced imaging, according to an embodiment. The operations of the method 400 are performed on computing hardware, such as that described above with respect to FIG. 1 or 2, or below with respect to FIG. 5 (e.g., circuit sets).

A user may record photographs or video with a device that includes a depth imager (e.g., operation 405). The video may include objects, such as people, surfaces (e.g., tables, walls, etc.), animals, toys, etc. As the video or photo is being taken, as it is being encoded into a storage device, or after it is encoded, the object meta-tagging in the produced media may be implemented iteratively over the captured frames.

The iterative processing of the captured media may start by determining whether a current frame includes object identifications (IDs) or context for the object (e.g., decision 410). If the answer is yes, then the method 400 proceeds to determining whether there are other frames to process (e.g., decision 430). If the answer is no, the method 400 analyzes the frame to, for example, detect planes or segment objects using either the visual information (e.g., image) or depth information (e.g., depth image) (e.g., operation 415). Such segmentation may involve a number of computer vision techniques, such as Gabor filters, Hough transform, edge detection, etc., to segment these regions of interest.

Once the frame is segmented, the method 400 proceeds to classify the detected objects (e.g., operation 420). Classification may include a number of techniques, such a neural network classifiers, stochastic classifiers, expert systems, etc. The classification will include both the image and the depth image as inputs. Thus, the captured depth information is intrinsic to the classification process. The classifier will provide the object ID. For example, if an object is segmented because four connected line segments were detected in the frame, there is no information about what the object is, e.g., is it a box, a mirror, a sheet of paper, etc. The classifier accepts the image and depth image as input and provides the answer, e.g., a sheet of paper. This, the object is given an ID, which is added to the frame, or the enhanced media. The object ID may be registered to the frame locations such that, for example, clicking on an area of a frame containing the object allows for a direct correlation to the object ID.

Just knowing what an object is, however, may not inform a computational device properties of the object. Thus, the method 400 may also retrieve context information for the object (e.g., operation 425) based on the classification. Such context information may be stored in a database and indexed by object class, object type, etc. For example, if a surface is detected to be a brick wall, the context may include a roughness model, a hardness model, a light refraction model, etc. Thus, The wall may be segmented the homogenous plane in the depth image (e.g., a flat vertical surface), classified as a brick wall because of its planar characteristics (e.g., small depth variations at the mortar lines) that corresponds to a visual pattern (e.g., red bricks and grey mortar), and looked up in a database to determine that the bricks have a first texture and the mortar has a second texture. This context may then be added to the media.

Including the context increases the utility of the produced media for other applications. For example, the method 400 may be used to film a room for a house showing. The composite media may be provided to a virtual reality application. The virtual reality application may allow the user to “feel” the brick wall via a haptic feedback device because the roughness model is already indicated (e.g., embedded) in the produced media. Further, the same composite media may be used for a game in which a ball is bounced around the space. Because such context as hardness, planar direction, etc. is already embedded the in the media, the game does not have to reprocess or guess as to how the ball should behave when interacting with the various surfaces. Thus, pre-identifying and providing context for detected objects reduces aggregate computation for object identification or interaction, enhancing the usefulness of the imaging system.

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### ADDITIONAL NOTES & EXAMPLES

Example 1 is at least one machine readable medium including instructions for enhanced imaging, the instructions, when executed by a machine, cause the machine to perform operations comprising: sampling light from the environment to create an image; sampling reflected energy from the environment contemporaneously to the sampling of the light to create a depth image of the environment; applying a classifier to the image and the depth image to provide a set of object properties of an object in the environment; and constructing a composite image that includes a portion of the image in which the object is represented, a corresponding portion of the depth image, and the set of object properties.

In Example 2, the subject matter of Example 1 optionally includes, wherein sampling the reflected energy includes: emitting light into the environment; and sampling the emitted light.

In Example 3, the subject matter of Example 2 optionally includes, wherein the emitted light is in a pattern and wherein sampling the emitted light includes measuring a deformation of the pattern to create the depth image.

In Example 4, the subject matter of any one or more of Examples 2-3 optionally include, wherein sampling the emitted light includes measuring a time-of-flight of sub-samples of the emitted light to create the depth image.

In Example 5, the subject matter of any one or more of Examples 1-4 optionally include, wherein sampling the reflected energy includes: emitting a sound into the environment; and sampling the emitted sound.

In Example 6, the subject matter of any one or more of Examples 1-5 optionally include, wherein applying the classifier includes applying a classifier in a device that includes a detector used to perform the sampling of the reflected light.

In Example 7, the subject matter of any one or more of Examples 1-6 optionally include, wherein applying the classifier includes applying a classifier in a device that is remote from a device that includes a detector used to perform the sampling of the reflected light.

In Example 8, the subject matter of any one or more of Examples 1-7 optionally include, wherein the set of object properties includes at least one of: object shape; object surface type, object hardness, object identification, or sound absorption.

In Example 9, the subject matter of any one or more of Examples 1-8 optionally include, wherein applying the classifier includes: performing object recognition on the image and the depth image to identify the object; and extracting properties of the object from a dataset corresponding to the object.

In Example 10, the subject matter of Example 9 optionally includes, wherein the dataset is remote from a device that includes a detector used to perform the sampling of the reflected light.

In Example 11, the subject matter of any one or more of Examples 1-10 optionally include, wherein constructing the composite image includes: encoding the depth image as a channel of the image; and including a geometric representation of the object, the geometric representation registered to the image.

In Example 12, the subject matter of Example 11 optionally includes, wherein the composite image includes the set of properties as attributes to the geometric representation of the object.

In Example 13, the subject matter of Example 12 optionally includes, wherein the composite image is a frame from a video of composite images, and wherein the geometric representation of the object changes between frames of the video.

Example 14 is a device for enhanced imaging, the device comprising: a detector to sample light from the environment to create an image; a depth sensor to sample reflected energy from the environment contemporaneously to the sampling of the light to create a depth image of the environment; a classifier to accept the image and the depth image and to provide a set of object properties of an object in the environment; and a compositor to construct a composite image that includes a portion of the image in which the object is represented, a corresponding portion of the depth image, and the set of object properties.

In Example 15, the subject matter of Example 14 optionally includes, wherein to sample the reflected energy includes: an emitter to emit light into the environment; and the detector to sample the emitted light.

In Example 16, the subject matter of Example 15 optionally includes, wherein the emitted light is in a pattern and wherein to sample the emitted light includes the detector to measure a deformation of the pattern to create the depth image.

In Example 17, the subject matter of any one or more of Examples 15-16 optionally include, wherein to sample the emitted light includes the detector to measure a time-of-flight of sub-samples of the emitted light to create the depth image.

In Example 18, the subject matter of any one or more of Examples 14-17 optionally include, wherein to sample the reflected energy includes: an emitter to emit a sound into the environment; and the detector to sample the emitted sound.

In Example 19, the subject matter of any one or more of Examples 14-18 optionally include, wherein the classifier is in a device that includes a detector used to perform the sampling of the reflected light.

In Example 20, the subject matter of any one or more of Examples 14-19 optionally include, wherein the classifier is in a device that is remote from a device that includes a detector used to perform the sampling of the reflected light.

In Example 21, the subject matter of any one or more of Examples 14-20 optionally include, wherein the set of object properties includes at least one of: object shape; object surface type, object hardness, object identification, or sound absorption.

In Example 22, the subject matter of any one or more of Examples 14-21 optionally include, wherein to provide the set of object properties includes the classifier to: perform object recognition on the image and the depth image to identify the object; and extract properties of the object from a dataset corresponding to the object.

In Example 23, the subject matter of Example 22 optionally includes, wherein the dataset is remote from a device that includes a detector used to perform the sampling of the reflected light.

In Example 24, the subject matter of any one or more of Examples 14-23 optionally include, wherein to construct the composite image includes the compositor to: encode the depth image as a channel of the image; and include a geometric representation of the object, the geometric representation registered to the image.

In Example 25, the subject matter of Example 24 optionally includes, wherein the composite image includes the set of properties as attributes to the geometric representation of the object.

In Example 26, the subject matter of Example 25 optionally includes, wherein the composite image is a frame from a video of composite images, and wherein the geometric representation of the object changes between frames of the video.

Example 27 is a method for enhanced imaging, the method comprising: sampling light from the environment to create an image; sampling reflected energy from the environment contemporaneously to the sampling of the light to create a depth image of the environment; applying a classifier to the image and the depth image to provide a set of object properties of an object in the environment; and constructing a composite image that includes a portion of the image in which the object is represented, a corresponding portion of the depth image, and the set of object properties.

In Example 28, the subject matter of Example 27 optionally includes, wherein sampling the reflected energy includes: emitting light into the environment; and sampling the emitted light.

In Example 29, the subject matter of Example 28 optionally includes, wherein the emitted light is in a pattern and wherein sampling the emitted light includes measuring a deformation of the pattern to create the depth image.

In Example 30, the subject matter of any one or more of Examples 28-29 optionally include, wherein sampling the emitted light includes measuring a time-of-flight of sub-samples of the emitted light to create the depth image.

In Example 31, the subject matter of any one or more of Examples 27-30 optionally include, wherein sampling the reflected energy includes: emitting a sound into the environment; and sampling the emitted sound.

In Example 32, the subject matter of any one or more of Examples 27-31 optionally include, wherein applying the classifier includes applying a classifier in a device that includes a detector used to perform the sampling of the reflected light.

In Example 33, the subject matter of any one or more of Examples 27-32 optionally include, wherein applying the classifier includes applying a classifier in a device that is remote from a device that includes a detector used to perform the sampling of the reflected light.

In Example 34, the subject matter of any one or more of Examples 27-33 optionally include, wherein the set of object properties includes at least one of: object shape; object surface type, object hardness, object identification, or sound absorption.

In Example 35, the subject matter of any one or more of Examples 27-34 optionally include, wherein applying the classifier includes: performing object recognition on the image and the depth image to identify the object; and extracting properties of the object from a dataset corresponding to the object.

In Example 36, the subject matter of Example 35 optionally includes, wherein the dataset is remote from a device that includes a detector used to perform the sampling of the reflected light.

In Example 37, the subject matter of any one or more of Examples 27-36 optionally include, wherein constructing the composite image includes: encoding the depth image as a channel of the image; and including a geometric representation of the object, the geometric representation registered to the image.

In Example 38, the subject matter of Example 37 optionally includes, wherein the composite image includes the set of properties as attributes to the geometric representation of the object.

In Example 39, the subject matter of Example 38 optionally includes, wherein the composite image is a frame from a video of composite images, and wherein the geometric representation of the object changes between frames of the video.

Example 40 is at least one machine readable medium including instructions that, when executed by a machine, cause the machine to perform any of the methods of Examples 27-39.

Example 41 is a system comprising means to perform any of the methods of Examples 27-39.

Example 42 is a system for enhanced imaging, the instructions, the system comprising: means for sampling light from the environment to create an image; means for sampling reflected energy from the environment contemporaneously to the sampling of the light to create a depth image of the environment; means for applying a classifier to the image and the depth image to provide a set of object properties of an object in the environment; and means for constructing a composite image that includes a portion of the image in which the object is represented, a corresponding portion of the depth image, and the set of object properties.

In Example 43, the subject matter of Example 42 optionally includes, wherein sampling the reflected energy includes: means for emitting light into the environment; and means for sampling the emitted light.

In Example 44, the subject matter of Example 43 optionally includes, wherein the emitted light is in a pattern and wherein sampling the emitted light includes means for measuring a deformation of the pattern to create the depth image.

In Example 45, the subject matter of any one or more of Examples 43-44 optionally include, wherein sampling the emitted light includes means for measuring a time-of-flight of sub-samples of the emitted light to create the depth image.

In Example 46, the subject matter of any one or more of Examples 42-45 optionally include, wherein sampling the reflected energy includes: means for emitting a sound into the environment; and means for sampling the emitted sound.

In Example 47, the subject matter of any one or more of Examples 42-46 optionally include, wherein applying the classifier includes means for applying a classifier in a device that includes a detector used to perform the sampling of the reflected light.

In Example 48, the subject matter of any one or more of Examples 42-47 optionally include, wherein applying the classifier includes means for applying a classifier in a device that is remote from a device that includes a detector used to perform the sampling of the reflected light.

In Example 49, the subject matter of any one or more of Examples 42-48 optionally include, wherein the set of object properties includes at least one of: object shape; object surface type, object hardness, object identification, or sound absorption.

In Example 50, the subject matter of any one or more of Examples 42-49 optionally include, wherein applying the classifier includes: means for performing object recognition on the image and the depth image to identify the object; and means for extracting properties of the object from a dataset corresponding to the object.

In Example 51, the subject matter of Example 50 optionally includes, wherein the dataset is remote from a device that includes a detector used to perform the sampling of the reflected light.

In Example 52, the subject matter of any one or more of Examples 42-51 optionally include, wherein constructing the composite image includes: means for encoding the depth image as a channel of the image; and means for including a geometric representation of the object, the geometric representation registered to the image.

In Example 53, the subject matter of Example 52 optionally includes, wherein the composite image includes the set of properties as attributes to the geometric representation of the object.

In Example 54, the subject matter of Example 53 optionally includes, wherein the composite image is a frame from a video of composite images, and wherein the geometric representation of the object changes between frames of the video.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. At least one machine readable medium including instructions for enhanced imaging, the instructions, when executed by a machine, cause the machine to perform operations comprising:
sampling light from the environment to create an image;
sampling reflected energy from the environment contemporaneously to the sampling of the light to create a depth image of the environment;
applying a classifier to the image and the depth image to provide a set of object properties of an object in the environment; and
constructing a composite image that includes a portion of the image in which the object is represented, a corresponding portion of the depth image, and the set of object properties.

2. The machine readable medium of claim 1, wherein sampling the reflected energy includes:
emitting light into the environment; and
sampling the emitted light.

3. The machine readable medium of claim 1, wherein applying the classifier includes applying a classifier in a device that includes a detector used to perform the sampling of the reflected light.

4. The machine readable medium of claim 1, wherein the set of object properties includes at least one of: object shape; object surface type, object hardness, object identification, or sound absorption.

5. The machine readable medium of claim 1, wherein applying the classifier includes:
performing object recognition on the image and the depth image to identify the object; and
extracting properties of the object from a dataset corresponding to the object.

6. The machine readable medium of claim 1, wherein constructing the composite image includes:
encoding the depth image as a channel of the image; and
including a geometric representation of the object, the geometric representation registered to the image.

7. The machine readable medium of claim 6, wherein the composite image includes the set of properties as attributes to the geometric representation of the object.

8. The machine readable medium of claim 7, wherein the composite image is a frame from a video of composite images, and wherein the geometric representation of the object changes between frames of the video.

9. A device for enhanced imaging, the device comprising:
a detector to sample light from the environment to create an image;
a depth sensor to sample reflected energy from the environment contemporaneously to the sampling of the light to create a depth image of the environment;
a classifier to accept the image and the depth image and to provide a set of object properties of an object in the environment; and
a compositor to construct a composite image that includes a portion of the image in which the object is represented, a corresponding portion of the depth image, and the set of object properties.

10. The device of claim 9, wherein to sample the reflected energy includes:
an emitter to emit light into the environment; and
the detector to sample the emitted light.

11. The device of claim 9, wherein the classifier is in a device that includes a detector used to perform the sampling of the reflected light.

12. The device of claim 9, wherein the set of object properties includes at least one of: object shape; object surface type, object hardness, object identification, or sound absorption.

13. The device of claim 9, wherein to provide the set of object properties includes the classifier to:
perform object recognition on the image and the depth image to identify the object; and
extract properties of the object from a dataset corresponding to the object.

14. The device of claim 9, wherein to construct the composite image includes the compositor to:
encode the depth image as a channel of the image; and
include a geometric representation of the object, the geometric representation registered to the image.

15. The device of claim 14, wherein the composite image includes the set of properties as attributes to the geometric representation of the object.

16. The device of claim 15, wherein the composite image is a frame from a video of composite images, and wherein the geometric representation of the object changes between frames of the video.

17. A method for enhanced imaging, the method comprising:
sampling light from the environment to create an image;
sampling reflected energy from the environment contemporaneously to the sampling of the light to create a depth image of the environment;
applying a classifier to the image and the depth image to provide a set of object properties of an object in the environment; and
constructing a composite image that includes a portion of the image in which the object is represented, a corresponding portion of the depth image, and the set of object properties.

18. The method of claim 17, wherein sampling the reflected energy includes:
emitting light into the environment; and
sampling the emitted light.

19. The method of claim 17, wherein applying the classifier includes applying a classifier in a device that includes a detector used to perform the sampling of the reflected light.

20. The method of claim 17, wherein the set of object properties includes at least one of: object shape; object surface type, object hardness, object identification, or sound absorption.

21. The method of claim 17, wherein applying the classifier includes:
performing object recognition on the image and the depth image to identify the object; and
extracting properties of the object from a dataset corresponding to the object.

22. The method of claim 17, wherein constructing the composite image includes:
encoding the depth image as a channel of the image; and
including a geometric representation of the object, the geometric representation registered to the image.

23. The method of claim 22, wherein the composite image includes the set of properties as attributes to the geometric representation of the object.

24. The method of claim 23, wherein the composite image is a frame from a video of composite images, and wherein the geometric representation of the object changes between frames of the video.
